(19) United States
(12) Patent Application Publication
(10) Pub. No.: US 2001/0004887 A1
(43) Pub. Date: Jun. 28, 2001

(54) Intake system

(76) Inventors: Seon-Yang Hwang, Anyang-City (KR); Tae-Ho Kwon, Seoul (KR)

Correspondence Address: CHRISTIE, PARKER & HALE, LLP, 350 WEST COLORADO BOULEVARD, SUITE 500, PASADENA, CA, 91105, US

(21) Appl. No.: 09/752,424

(22) Filed: Dec. 27, 2000

(30) Foreign Application Priority Data
Dec. 28, 1999 (KR) 99-63719

(51) Int. Cl. F02M 35/10

(52) U.S. Cl. 123/184.57

(57) ABSTRACT

An intake system adapted and constructed to reduce noise without change or alternation to existing structure, the system comprising: an intake duct formed for intake of air; a resonator formed at one side of the intake duct; a flow passage connected to the intake duct for air to be infused from the intake duct; a main valve formed in the flow passage for controlling amount of air infused from the intake duct; a throttle body mounted with an idle speed actuator formed at an air route communicatively equipped at the flow passage for controlling the amount of air; and a connecting member for connecting the air route and the resonator.

### BACKGROUND OF THE INVENTION

1. Field of the Invention

The present invention relates to an intake system, and more particularly to an intake system adapted to improve air current sound generated by air passing through a throttle body.

2. Description of the Prior Art

In general, air infused into an engine flows in the follow fashion. In other words, the air filtered by an air cleaner is adjusted in volume thereof by open duct at a throttle valve disposed in the throttle body and sucked into a cylinder through each manifold.

Particularly, the throttle body includes a throttle valve for controlling sucked air amount, a bypass system for bypassing a predetermined amount of air for obtaining idling rotating speed, a throttle position sensor for detecting a throttle valve open duct and a dash pat.

As illustrated in FIG. 1, the throttle body thus constructed serves to control air amount necessary for maintaining a resolution per minute (RPM) according to an idle speed actuator 11 during idling. At this time, there is generated an air current sound of white noise while the air passes the idle speed actuator 11. The generated noise is amplified in a surge tank (not shown) to be radiated and heard at the outside. Meanwhile, unexplained reference numeral 12 in FIG. 1 is a main valve for controlling air amounted at synchronization.

The air current sound thus created in idling, which is heard loudly especially in cold, freezing weather, can be reduced by improvement in idle speed actuator 11 itself, mounting an air controller in flow passage or thickening wall thickness of surge tank.

However, there is a problem in that thickened wall of surge tank increases weight, manufacturing cost and involves a manufacturing difficulty.

### SUMMARY OF THE INVENTION

The present invention is disclosed to solve the aforementioned problems and it is an object of the present invention to provide an intake system adapted and constructed to reduce noise without change or alteration to existing structure.

In accordance with the object of the present invention, there is provided an intake system, the system comprising:

an intake duct formed for intake of air;

a resonator formed at one side of the intake duct;

a flow passage connected to the intake duct for air to be infused from the intake duct;

a main valve formed in the flow passage for controlling amount of air infused from the intake duct;

a throttle body mounted with an idle speed actuator formed at an air route communicatively equipped at the flow passage for controlling the amount of air; and

a connecting member for connecting the air route and the resonator.

The air route according to the present invention communicate at one end thereof with the flow passage while the other end thereof comes out of the flow passage to have the idle speed actuator installed at one side thereof with the connecting member equipped at the other side thereof.

### BRIEF DESCRIPTION OF THE DRAWINGS

For fuller understanding of the nature and object of the invention, reference should be made to the following detailed description taken in conjunction with the accompanying drawings in which:

FIG. 1 is a schematic drawing for partially illustrating a throttle body according to the prior art; and

FIG. 2 is a schematic drawing for partially illustrating an intake system according to the present invention.

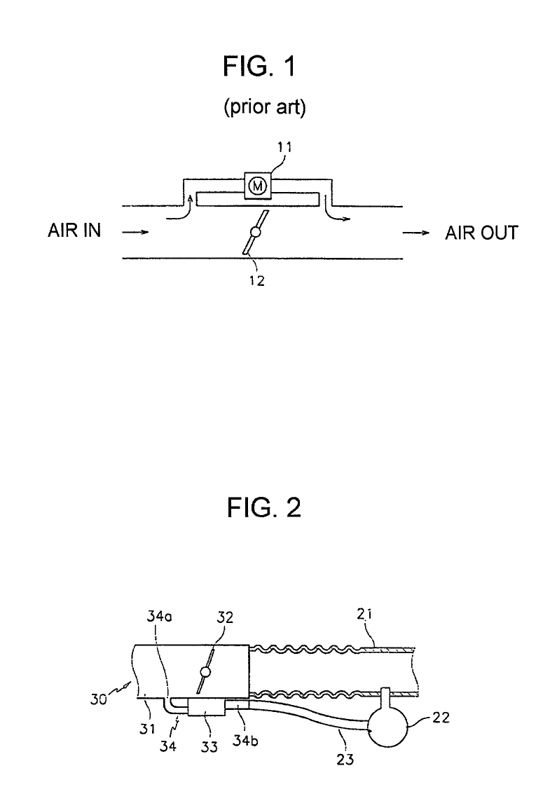

### DETAILED DESCRIPTION OF THE INVENTION

Now, preferred embodiment of the present invention will be described in detail with reference to the accompanying drawings.

FIG. 2 is a schematic drawing for partially illustrating an intake system according to the present invention.

As illustrated in the drawings, the intake system according to the present invention describes a structure where an air current sound generated by air passing through a throttle body is reduced with change or alternation to existing construction.

At this time, an intake system according to the prior art will be eliminated in description thereof while only an intake system according to the present invention will be described in detail.

The intake system according to the present invention includes an intake duct 21 formed for intake of air, a resonator formed at one side of the intake duct 21, a flow passage 31 connected to the intake duct 21 for air to be infused from the intake duct 21; a main valve 32 formed in the flow passage for controlling amount of air infused from the intake duct 21, a throttle body 30 mounted with an idle speed actuator 33 formed at an air route 32 communicatively equipped at the flow passage 31 for controlling the amount of air; and a connecting member 23 for connecting the air route 34 and the resonator 22.

The air route 34 communicates at one end thereof 34a with flow passage 31 while the other end thereof 34b comes out of the flow passage 31 to have the idle speed actuator 33 installed at one side thereof with the connecting member 23 equipped at the other side thereof 34b.

Now, operation of intake system according to the present invention thus constructed will be described. At this time, operation of a general intake system ill be omitted in explanation thereof but operation of intake system according to the present invention will be described.

Referring again to FIG. 2, there connecting member 23 which is a hose is pulled out from the noise-removing resonator 22 formed at the intake duct 21 to be directly connected to the throttle body 30. Particularly, the air route 34 is exposed out of the flow passage 31 not to be connected again to the flow passage 31 but to be directly connected to the resonator 22 through the connecting member 23, such that the throttle body 30 becomes simplified in structure thereof.

In other words, the throttle body 30 is connected to the resonator (noise remover) 22 which has only particular source due to effect of blocking from outside noise according to increased internal air impedance, noise generated by surge tank according to internal noise and the like, such that air current sound, accelerated engine noise and the like can be all removed.

As apparent from the foregoing, there is an advantage in the intake system thus described according to the present invention in that the resonator mounted on the intake duct improves anti-part of performance curve to thereby connect a first flow speed torque and a second high speed torque directly, improving a driving stillness according to decreased noise.

There is another advantage in that the throttle body is simplified is structure thereof to reduce a manufacturing cost and discharge of exhaust gas, and to improve fuel consumption rate.

Having described preferred embodiments of the invention with reference to the accompanying drawing, it is to be understood that the various changes and modifications may be effected therein by one skilled in the art without departing from the scope or spirit of the invention as defined in the appended claims.

What is claimed is:

1. An intake system, the system comprising:
an intake duct formed for intake of air;
a resonator formed at one side of the intake duct;
a flow passage connected to the intake duct for air to be infused from the intake duct;
a main valve formed in the flow passage for controlling amount of air infused from the intake duct;
a throttle body mounted with an idle speed actuator formed at an air route communicatively equipped at the flow passage for controlling the amount of air; and
a connecting member for connecting the air route and the resonator.

2. The system as defined in claim 1, wherein the connecting member is a hose.

3. The system as defined in claim 1, wherein the air route communicates at one end thereof with the flow passage while the other end thereof comes out of the flow passage to have the idle speed actuator installed at one side thereof with the connecting member equipped at the other side thereof.
